(19) United States
(12) Patent Application Publication
(10) Pub. No.: US 2024/0390226 A1
(43) Pub. Date: Nov. 28, 2024

(54) Acupressure Neck Pillow

(71) Applicant: J. Michael Lapinsky, Malibu, CA (US)

(72) Inventor: J. Michael Lapinsky, Malibu, CA (US)

(21) Appl. No.: 18/201,890

(22) Filed: May 25, 2023

(51) Int. Cl. A61H 39/04

(52) U.S. Cl. CPC A61H 39/04; A61H 2205/04

(57) ABSTRACT

The present invention discloses an enhanced design of an orthotic device with symmetrical estimations in stature and side width to provide enhanced stability. The acupressure neck pillow is a versatile Orthotic that is great for a variety of relaxation techniques, exercises, and stretches that assist to restore and recover problematic soft tissues in the neck. It further helps restore issues associated with tension and stress, including headache, cervical syndrome, tension at the base of the skull (such as knotted muscles) with just few minutes of use per day.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The invention relates to orthotic devices. In a particular form, the present invention relates to an assembly for acupressure Neck and Shoulder Pain Trigger Point Therapy Massager and Posture Corrector with Acupressure and Occipital Release Nodes.

### Description of the Related Art

The human neck and back are made up of small bones called vertebrae. These are stacked on top of each other to form the spinal column.

The spinal column supports head and protects the spinal cord. This is the main structure which links the network of nerves throughout your body. Messages travel along this network sending sensations, such as pain, to your brain.

The top seven bones in the spinal column form human neck, and these are called the cervical vertebrae. The bones are linked together by facet joints. These are small joints between your vertebrae that, together with your neck muscles, allow you to move your head in any direction.

Between the vertebrae are discs of cartilage. The discs act as shock absorbers and give the spine its flexibility. A slipped disc occurs when one of these discs slips slightly out of its natural position in the spine.

Neck pain is very common and most of us have it at some point in our lives. Usually, neck pain is the result of holding neck in the same position for too long. However, other things can also cause or contribute to neck pain, such as: worry or stress, sleeping awkwardly, an accident, which can cause whiplash, a sprain or a strain, a flare-up of cervical spondylosis; which can happen as the discs and joints in the spine age.

Present-day home cervical traction devices involve complicated and/or cumbersome equipment of numerous parts such as the over-the-door units that often require the attachment of weights and the like. Such devices have been criticized generally for their lack of comfort, and specifically for the stress they cause on the lower back as well as the neck and shoulders, particularly during set-up. In addition, these prior art traction devices are frequently difficult to set-up and manage. Pillows of various types for supporting the neck and head of a supine person are also known in prior art.

There are multiple solutions that have been presented toward managing this situation. For instance, Traction pillow bearing Chinese patent 2,022,34367U is issued to Chinese inventor. The patent proposes a traction pillow comprising a supporting portion and a contacting portion which are connected mutually. The hardness of the supporting portion is larger than that of the contacting portion. When a user has a rest, the neck of the user is placed on the supporting portion with the higher hardness, and the supporting portion forcedly supports the neck of the user and provides a supporting force; and simultaneously, a traction force rearwards pulling the cervical vertebra of the user is formed by the gravity of the head of the user, the purpose of providing the traction force for the cervical vertebra of the user is achieved, and the purpose of recovering the normal physiological curve of the cervical vertebra of the user is achieved. Similarly, the waist of the user is forcedly supported by the supporting portion, the supporting force is provided, a traction force for rearwards pulling the lumbar vertebra of the user is formed by the gravity of the back of the user, the purpose of providing the traction force for the lumbar vertebra of the user also can be achieved, and accordingly the purpose of recovering the normal physiological curve of the lumbar vertebra of the user is achieved.

Another patent on Inflatable cervical traction pillow bearing U.S. Pat. No. 4,805,603A is issued to C AND K Inc. The patent is on a cervical traction apparatus comprising a head/neck/shoulder support unit having a vertical slot in the region corresponding to the cervical area, said slot separating said unit into a first section and a second section, the upper surfaces of said support unit being shaped to receive the head, neck and shoulders of a reclining person, an inflatable air sac located within said unit between said first and second sections and means for inflating said air sac so as to cause said first and second sections to separate.

A Chinese patent on Cervical traction pillow bearing Chinese patent 2,009,39191Y is issued to Chinese inventor. The utility model relates to a cervical vertebrae traction pillow belonging to medical equipment's technology field which comprises a middle pillow, two side pillows positioned respectively at the left side and the right side of the middle pillow, ear grooves positioned at the side pillows, a cervico-occipital carrier positioned at the front of the middle pillow, and two traction bands. The two traction bands 5 arranged in shape are fixed to the middle pillow, and are positioned respectively at the rear of the cervico-occipital carrier. The height of the side pillow is 8 to 15 cm, the height of the middle pillow is 1 to 3 cm, and the concave height of the ear groove is 1 to 3 cm while the height of the cervico-occipital carrier is 5 to 10 cm. The height of the traction band is 3 to 6 cm, and a V shaped angle between the two traction bands is 30 degrees to 90 degrees. The utility model is characterized in that the cervical vertebrae can be held in a physiological posture and be kept in a physiological form during both the sleep on the side and the sleep on the back by using the utility model, and the cervical vertebrae can be slightly drawn during the sleep on the back; meanwhile the shortcoming that the ear is compressed during the sleep on the side is overcome, and the effects of improvement of sleep and treatment of neck pain and cervical vertebrae diseases are achieved.

Another patent on Locatable and adjustable cervical spine traction pillow bearing Chinese patent 1,016,69747A is issued to Chinese inventor. The invention relates to a locatable and adjustable cervical spine traction pillow, belonging to the technical field of health care and rehabilitation device manufacturing. The pillow comprises a heteromorphic pillow, a shouldering, a slide bar, a sleeve seat, a fastening screw and a traditional Chinese medicine bag, wherein, the shouldering is connected with the slide bar; the heteromorphic pillow is connected with the sleeve seat; the slide bar is penetrated into the sleeve seat, and is fixed by the fastening screw; the heteromorphic pillow is filled with the traditional Chinese medicine bag with the function of relaxing the muscles and stimulating the blood circulation; when in use, the fastening screw is loosened; the slide bar is adjusted back and forth according to the size of head and neck of a user to lead the distance between the heteromorphic pillow and the shouldering to be suitable for the user; the user lies on a bed, both sides of the shoulders are against the shouldering, and the head pillows on the heteromorphic pillow; the special mould of the pillow leads the neck to generate a drawing force, and ensures the use position not to offset, thus being conducive to rehabilitation of cervical spondylosis. The pillow has the advantages of reasonable design, simple structure and convenient use and the like.

Another Cervical traction pillow bearing Chinese patent 2,013,89106Y is issued to Chinse inventor. The utility model provides a medical care appliance, in particular a cervical traction pillow specifically designed for patients with cervical spondylosis, in order to solve the rehabilitation issue of cervical spondylosis. The cervical traction pillow is characterized in that an air pipe is arranged on the side of the cervical traction pillow, an air pipe is connected with an inflatable bag, an air valve is arranged at the end of the air pipe, and the air valve is unscrewed to achieve air inflation or deflation. A valve is arranged at the tail end of the inflatable bag, which can take in or take out the air. When in use, patients place the cervical traction pillow at the rear side of the neck to support the neck, so as to tilt the head backward naturally; by using the backward gravity and downward gravity of the head, especially in the sleep state, the neck muscles relax, and a delicate cervical traction force is formed. Long-term and continuous cervical traction can widen the cervical gap, reduce compression of the cervical spondylosis on vertebral artery and nerves, and eliminate the symptoms of cervical spondylosis, so as to achieve the therapeutic purpose. Since the cervical traction is carried out at rest or sleep, the cervical traction pillow can be used for long time, so as to significantly reduce the recurrence rate of cervical spondylosis. In addition, the cervical traction pillow can relieve neck stiffness and pain, shoulder and back heaviness and other fatigues resulting from imbalances in the neck caused by long-time head bowing and head-forward in daytime work and study, so as to play the role of health care.

Another patent on Adjustable cervical spine traction pillow bearing Chinese patent 2,0470,8478U is issued to Chinese inventor. The utility model relates to a kind of adjustable cervical spine traction pillow for health care, specifically a kind ofly by the treatment and health cervical spine traction pillow of Patients with Cervical Spondylopathy free adjustment tractive force size or personalized customization, can belong to health care technology field. It comprises pillow front end and pillow rear end, and pillow front end is connected by adjusting screw (rod) with pillow rear end; Also comprise the neck anticreep wing and neck fixing device; Two neck anticreep wings are positioned at adjustable cervical spine traction pillow two ends, and connect pillow front end and pillow rear end; Neck fixing device comprises occiput pad and studdle, and studdle penetrates pillow front end and is fixed on pillow side, rear end, and occiput pad is arranged at studdle top. The utility model simple and ingenious structure, greatly can improve traction effect, reduces to draw the uncomfortable property that may bring, as hyper-traction etc., and simple to operation.

Another patent on adjustable traction pillow for cervical vertebra and lumbar vertebra bearing Chinese patent 2,751,765Y is issued to Chinese inventor. The utility model relates to an adjustable traction pillow for cervical vertebras and lumbar vertebras, which belongs to bed articles and particularly relates to a traction pillow with the function of treatment. A pillow body of the utility model is a hollow rubber or plastic piece, edge is connected with a flexible hose which passes through a cavity, the end of the flexible hose is connected with an aerating capsule provided with a one-way valve, and an air escape valve is also connected with the end of the flexible hose. The traction pillow has the advantages of simple structure, convenient use and a certain curative effect.

There are multiple solutions that have been presented in the prior art. However, these solutions are limited and restricted to their conventional architecture, and installation system and have considerable shortcomings which adversely affect the convenience with which they can be used. The prior systems have certain limitations including the design of assemblies which make them not suitable for every type of user. Moreover, the ease-of-use ability of these assemblies is also questionable.

It has to be noted that the current invention proposes an assembly with multiple advancements including a structure with symmetrical measurements in height and side width that make it more stable and easier to wear for the user. The Neck pillow or Cervical Traction Pillow is a versatile Orthotic that is great for a variety of relaxation techniques, exercises and stretches that assist to restore and recover problematic soft tissues in the neck. It further helps restore issues associated with tension and stress, including headache, cervical syndrome, tension at the base of the skull (such as knotted muscles) and TMJ with just 10 minutes of use per day. The assembly is made of high-density EVA foam to allow for changes to occur over time.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved form of a Neck Pillow used to elicit changes in soft and hard tissues over time.

It is another objective of the invention to provide an orthotic device which being used is increasingly agreeable for the patient.

It is further the objective of the invention to give an orthotic device which is advanced level of Orthotic Device for Neck and Shoulder Pain with a Trigger Point Therapy Massager and Posture Corrector with Acupressure and Occipital Release Nodes.

It is further the objective of the invention to provide an inner and outer section. The outer section of the neck pillow unfolds to reveal a smaller in-diameter neck pillow designed for a more pronounced curve of the neck vertebrae. The curvature of the neck pillow is adjustable to provide customized support for different users. The inner section of the neck pillow contains acupressure nodes that apply gentle pressure to specific acupressure points on the neck, providing therapeutic benefits.

It is also the objective of the invention to provide a device of the type described which provides a variety of relaxation techniques, exercises, and stretches that assist to restore and recover problematic soft tissues in the neck.

It is also the objective of the invention to provide a Cervical Orthotic which provides helps to restore issues associated with tension & stress which includes headache, cervical syndrome, and tension at the base of the skull.

It is also the objective of the invention to provide an acupressure neck pillow provides adjustable curvature for improved neck support and pain relief. The acupressure nodes stimulate blood circulation, reduce muscle tension, and promote relaxation.

It is further the objective of the invention to restore issues associated with stiff neck, straight neck, military neck, and forward head posture with just few minutes of use per day.

It is another objective of the invention to provide a device that is crafted from multiple materials including but not limited to polyurethane foam to give users the support needed for optimal tissue strengthening.

It is moreover the objective of the invention to provide an assembly that can be used in seconds and is effective including but not limited to chronic neck pain, stress & tension headaches, poor sleep, shoulder tension and much more.

It is further the objective of the invention to provide assembly made of high-quality materials that are hypoallergenic and breathable, providing comfort and durability. The pillow cover is removable and machine washable for easy maintenance.

A further object is to provide an assembly that is simple, rapidly adjusted and easy to use.

It is also the objective of the invention to assist to use in seconds and effectively stretches neck, shoulders and back in order to help decompress your spine, loosen tense jaw muscles, increase blood flow, and stretch your neck muscles while helping to align the natural cervical curve.

A still further object is to provide an assembly that is economical in cost to manufacture.

Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 shows multiple configurational views of the present invention.

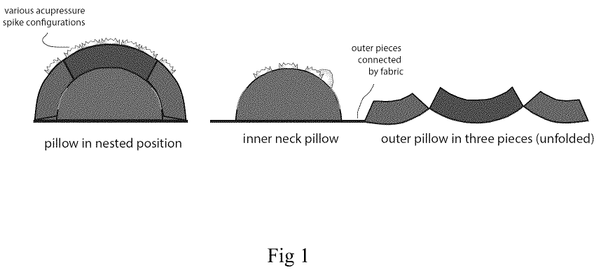

FIG. 2 shows the perspective use of assembly as per preferred embodiments of the invention.

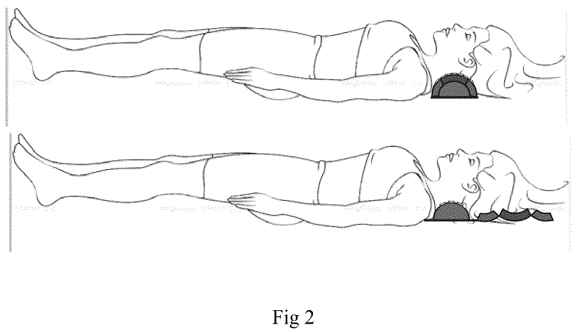

FIG. 3 shows the effect of the pillow as per preferred embodiments of the invention.

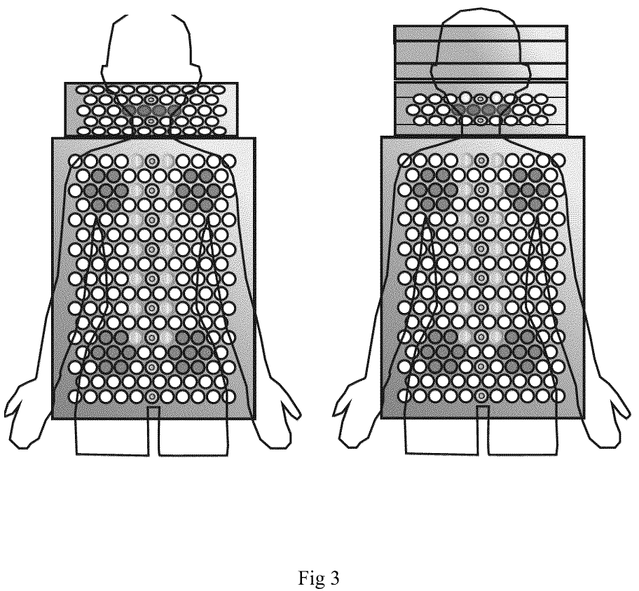

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention is directed to a cervical orthotic Pillow which is a Chiropractic Orthotic Device for Neck and Shoulder Pain Trigger Point Therapy Massager and Posture Corrector with Acupressure and Occipital Release Nodes.

Whether the pain is caused by a car accident, a fall, or simply poor posture, abnormal cervical lordosis can adversely affect nerve, ligament, and muscle function. As shown in numerous research studies, those adverse effects can be reversed by correcting cervical lordosis, relieving pain and improving overall health.

A simple orthotic device is engineered with curves, angles and ridges which is symmetrical in measurement. The symmetrical sides both horizontally and vertically allows a stable assembly.

The device as per its further embodiments provides a health care equipment, is specifically dedicated to the proposition of cervical traction with cervical spondylosis pillow. After the cervical traction pillow placed on the neck portion of the neck, the head natural tilt backward. The downward gravity, especially in the sleep state, causes the neck muscle relaxation. This also assist in forming delicate cervical traction through continuous long-term cervical traction cervical gap widening which can reduce compression of cervical lesions of vertebral artery and nerve, eliminate the symptoms of cervical spondylosis, the therapeutic purpose. Since the patient is resting during sleep cervical traction, long-term continuous use, a significant reduction in the recurrence rate of neck pains. At the same time during the day its use can also relieve work stress, study bow pain, and neck forward imbalance that causes stiffness, pain, fatigue and other heavy shoulder and back, play a role in health care.

The assembly as per its further embodiments includes acupressure NestPillow comprising an inner section and an outer section. The outer section of the pillow contains a series of acupressure nodes that are strategically placed to provide gentle pressure to specific acupressure points on the neck. The acupressure nodes are designed to stimulate blood circulation, reduce muscle tension, and promote relaxation. The outer section of the pillow unfolds to reveal the inner section which is comprised of a smaller in-diameter neck pillow designed for a more pronounced curve of the neck vertebrae. The curvature of the neck pillow is adjustable by pulling or pushing the outer section to increase or decrease the curvature

After receiving simple training and education, the patient will be able to properly position the device for low-stress, comfortable treatment at home.

The device as per its further embodiments is crafted from various suitable materials including but not limited to EVA foam to give the ultimate support needed for optimal spinal molding. The pillow has various acupressure spike configurations for adjustability, providing a custom-tailored therapy session. The neck orthosis is designed to be taken to the office, on long flights, road trips and just about anywhere. It is also small, lightweight, and easy to use, making it the superior choice for on-the-go therapy sessions. The acupressure neck pillow is made of high-quality materials that are hypoallergenic and breathable, providing comfort and durability. The pillow cover is removable and machine washable for easy maintenance.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1: A cervical pillow for stabilized placement of the head and neck of a person when in a generally horizontal position, comprising:
an inner section; and,
an outer section.
The acupressure neck pillow as per claim 1, wherein the inner section of the pillow contains a series of acupressure nodes that are strategically placed to provide gentle pressure to specific acupressure points on the neck.
The acupressure neck pillow as per claim 1, wherein the acupressure nodes are designed to stimulate blood circulation, reduce muscle tension, and promote relaxation.
The acupressure neck pillow as per claim 1, wherein the outer section of the pillow unfolds to reveal a smaller in diameter neck pillow designed for a more pronounced curve of the neck vertebrae.
The acupressure neck pillow as per claim 1, wherein the curvature of the neck pillow is adjustable by pulling or pushing the outer section to increase or decrease the curvature of the pillow.
The acupressure neck pillow as per claim 1, wherein the adjustable curvature allows for customized support for different users based on their neck size and preferences.
